(19) United States
(12) Patent Application Publication
(10) Pub. No.: US 2026/0304002 A1
(43) Pub. Date: Oct. 1, 2026

(54) IMAGING DEVICE

(71) Applicant: Sony Semiconductor Solutions Corporation, Kanagawa (JP)

(72) Inventor: Kohei Horii, Kanagawa (JP)

(21) Appl. No.: 19/474,780

(22) PCT Filed: Apr. 4, 2024
(86) PCT No.: PCT/JP24/13913

§ 371 Date: Oct. 13, 2025

(30) Foreign Application Priority Data
May 12, 2023 (JP) 2023-079652

(51) Int. Cl. H04N 25/772

(52) U.S. Cl. CPC H04N 25/772

(57) ABSTRACT

Imaging devices with suppressed white image blackening are disclosed. In one example, an imaging device includes a pixel unit including pixels that respectively photoelectrically convert incident light to generate a pixel signal. A first signal line transmits the pixel signal from the pixel unit, a signal processing unit converts the pixel signal into a digital value, a differentiation circuit between the first signal line and the signal processing unit differentiates the pixel signal and outputs a differentiation result, and a first comparison unit between the differentiation circuit and the signal processing unit compares the differentiation result with a predetermined threshold and outputs a comparison result to the signal processing unit.

### TECHNICAL FIELD

The present disclosure relates to an imaging device.

### BACKGROUND ART

In an imaging device such as a complementary metal oxide semiconductor (CMOS) image sensor, a slope-type analog to digital converter (ADC) is used for AD conversion of a pixel signal. The slope-type ADC includes a comparator and a counter, and the comparator compares a pixel signal with a reference signal and outputs a comparison result to the counter. The counter measures a period from when comparison between the pixel signal and the reference signal is started until an output of the comparator is inverted. A solid-state imaging element detects a level of the pixel signal on the basis of the period measured by the counter.

### CITATION LIST

### Patent Document

Patent Document 1: Japanese Patent Application Laid-Open No. 2020-28117

### SUMMARY OF THE INVENTION

### Problems to be Solved by the Invention

However, if strong light enters a pixel, electric charges may leak from a floating diffusion even though a transfer transistor in the pixel is turned off. In this case, as a voltage of a data signal line decreases, a pixel signal in a reset state not including data approaches a pixel signal including data. This causes a phenomenon in which a white image is somewhat blackened.

Thus, the present disclosure provides an imaging device capable of suppressing blackening of a white image.

### Solutions to Problems

An imaging device according to one aspect of the present disclosure includes: a pixel unit including a plurality of pixels that photoelectrically converts incident light to generate a pixel signal; a first signal line that transmits the pixel signal from the pixel unit; a signal processing unit that converts the pixel signal into a digital value; a differentiation circuit that is provided between the first signal line and the signal processing unit, differentiates the pixel signal, and outputs a differentiation result; and a first comparison unit that is provided between the differentiation circuit and the signal processing unit, compares the differentiation result with a predetermined threshold, and outputs a comparison result to the signal processing unit.

The first comparison unit inverts the comparison result in a case where an absolute value of the differentiation result of the pixel signal not including data of the incident light is equal to or greater than an absolute value of the threshold.

The signal processing unit sets the digital value to a maximum value when the first comparison unit inverts the comparison result.

The imaging device further includes a switching element provided between the differentiation circuit and the first signal line.

The switching element is brought into a conductive state during a period in which the pixel signal not including data of the incident light is converted into the digital value.

A plurality of the first signal lines is provided, and the differentiation circuit and the first comparison unit are provided for each of the first signal lines.

A plurality of the first signal lines is provided, and the differentiation circuit and the first comparison unit are provided on first signal lines intermittently selected among the plurality of first signal lines.

The signal processing unit includes a second comparison unit that compares the pixel signal with a reference signal having a voltage that changes with a predetermined inclination and inverts an output when the reference signal crosses the pixel signal, and a counter that counts a clock signal during a period from when change of the reference signal is started until the output is inverted by the second comparison unit. When the first comparison unit inverts the comparison result, the counter sets a count value to a maximum value.

The switching element is brought into a conductive state during a period in which the pixel signal including the data of the incident light is converted into the digital value.

The switching element is brought into a conductive state when a first period has elapsed after start of digital conversion of the pixel signal not including the data of the incident light, and is brought into a conductive state when the first period has elapsed after start of digital conversion of the pixel signal including the data of the incident light.

A plurality of the first signal lines is provided, and the differentiation circuit and the first comparison unit are provided in common for the plurality of first signal lines.

The imaging device further includes a plurality of first switching elements provided between the differentiation circuit and each of the plurality of first signal lines, and a plurality of second switching elements provided between the first comparison unit and the signal processing unit corresponding to each of the plurality of first signal lines.

The plurality of first switching elements and the plurality of second switching elements are provided corresponding to the plurality of first signal lines.

The plurality of first switching elements and the plurality of second switching elements are provided corresponding to the first signal lines intermittently selected among the plurality of first signal lines.

The imaging device further includes a current circuit that causes a current to flow through the first signal line, and the differentiation circuit and the first comparison unit are disposed at positions farther from the pixel unit than the current circuit.

### BRIEF DESCRIPTION OF DRAWINGS

FIG. 1 is a block diagram illustrating a configuration example of an imaging device in a first embodiment.

FIG. 2 is a block diagram illustrating a configuration example of a solid-state imaging element in the first embodiment.

FIG. 3 is a conceptual diagram illustrating an example of the solid-state imaging element in which a semiconductor chip of a pixel array unit and a semiconductor chip of a peripheral circuit unit are stacked.

FIG. 4 is a circuit diagram illustrating a configuration example of a pixel circuit in the first embodiment.

FIG. 5 is a view illustrating a configuration example of a differentiation circuit.

FIG. 6 is a view illustrating a configuration example of the differentiation circuit.

FIG. 7 is a view illustrating a configuration example of a Vref generation circuit that generates a threshold.

FIG. 8 is a timing chart indicating an example of operation of the imaging device according to the first embodiment.

FIG. 9 is a timing chart indicating an example of operation of an imaging device according to a second embodiment.

FIG. 10 is a timing chart indicating an example of operation of an imaging device according to a third embodiment.

FIG. 11 is a timing chart indicating an example of the operation of the imaging device according to the third embodiment.

FIG. 12 is a plan view illustrating an example of a layout position of a slope detection circuit.

FIG. 13 is a block diagram illustrating an example of a schematic configuration of a vehicle control system.

FIG. 14 is an explanatory diagram illustrating an example of installation positions of an outside-vehicle information detecting section and an imaging section.

### MODE FOR CARRYING OUT THE INVENTION

Hereinafter, specific embodiments to which the present technology is applied will be described in detail with reference to the drawings. The drawings are schematic or conceptual, and a ratio of each portion, and the like, are not necessarily the same as actual ones. In the specification and the drawings, similar elements to those described above concerning the previously described drawings are denoted by the same reference signs, and detailed description thereof will be appropriately omitted.

### First Embodiment

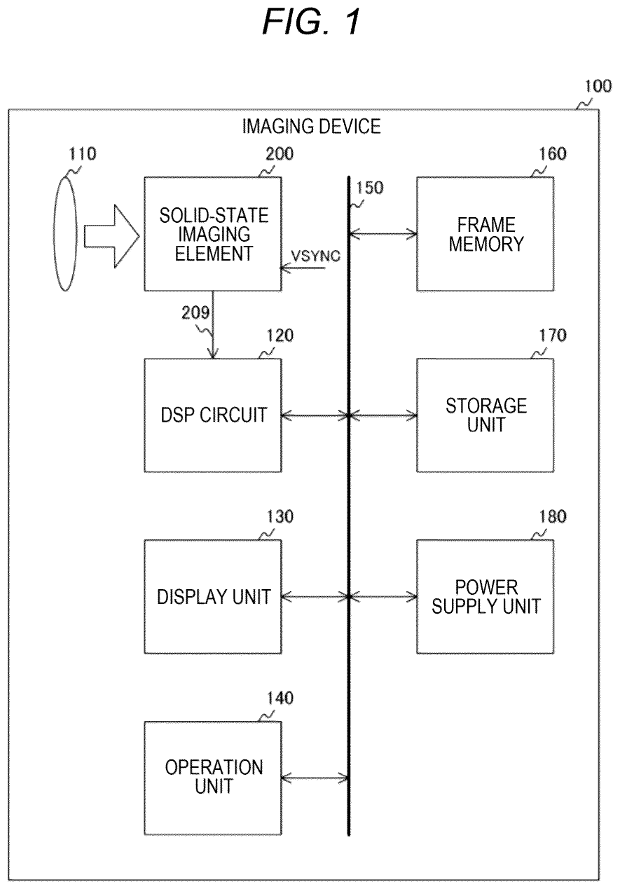

FIG. 1 is a block diagram illustrating a configuration example of an imaging device 100 in a first embodiment. The imaging device 100 is a device for capturing an image of a subject and generating image data thereof, and includes an optical unit 110, a solid-state imaging element 200, and a digital signal processing (DSP) circuit 120. The imaging device 100 further includes a display unit 130, an operation unit 140, a bus 150, a frame memory 160, a storage unit 170, and a power supply unit 180. As the imaging device 100, a camera mounted on a smartphone, an in-vehicle camera, and the like, are assumed.

The optical unit 110 condenses light from the subject, and guides the light to the solid-state imaging element 200. The solid-state imaging element 200 generates image data by photoelectric conversion. The solid-state imaging element 200 supplies the generated image data to a DSP circuit 120 via a signal line 209.

The DSP circuit 120 performs predetermined signal processing on the image data. The DSP circuit 120 outputs the processed image data to the frame memory 160, or the like, via the bus 150.

The display unit 130 displays the image data. As the display unit 130, for example, a liquid crystal panel or an organic electro luminescence (EL) panel is assumed. The operation unit 140 generates an operation signal in accordance with operation of a user.

The bus 150 is a common path through which the optical unit 110, the solid-state imaging element 200, the DSP circuit 120, the display unit 130, the operation unit 140, the frame memory 160, the storage unit 170, and the power supply unit 180 exchange data with each other.

The frame memory 160 holds the image data. The storage unit 170 stores various kinds of data such as the image data. The power supply unit 180 supplies power to the solid-state imaging element 200, the DSP circuit 120, the display unit 130, and the like.

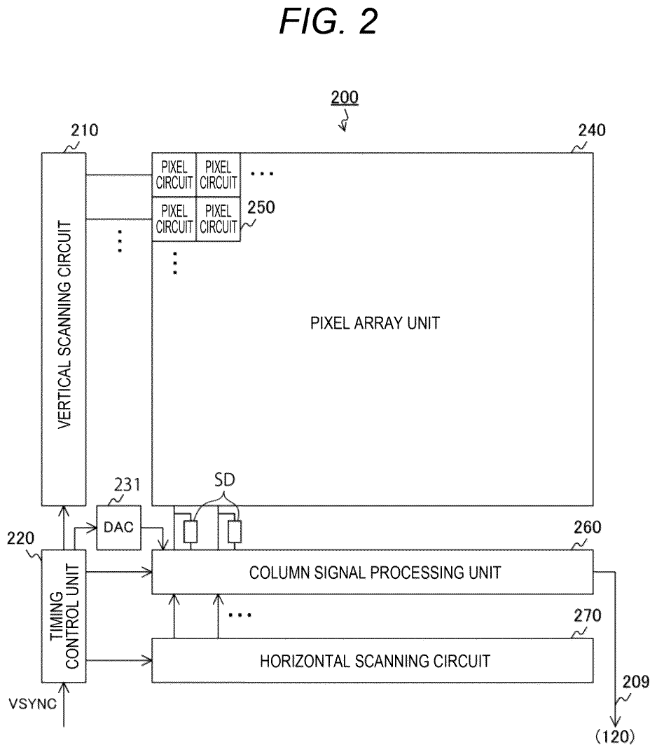

FIG. 2 is a block diagram illustrating a configuration example of the solid-state imaging element 200 in the first embodiment. The solid-state imaging element 200 includes a vertical scanning circuit 210, a timing control unit 220, a digital to analog converter (DAC) 231, a pixel array unit 240, a column signal processing unit 260, a horizontal scanning circuit 270, and a slope detection circuit SD.

In the pixel array unit 240, a plurality of pixel circuits 250 is arranged in a two-dimensional grid pattern. Hereinafter, a set of the pixel circuits 250 arranged in a predetermined horizontal direction will be referred to as a “pixel row”, and a set of the pixel circuits 250 arranged in a direction perpendicular to the pixel row will be referred to as a “pixel column”.

The vertical scanning circuit 210 sequentially drives the pixel rows to cause the pixel circuits 250 to perform output.

The timing control unit 220 controls operation timings of the vertical scanning circuit 210, the DAC 231, the column signal processing unit 260, and the horizontal scanning circuit 270 in synchronization with a vertical synchronization signal VSYNC. The vertical synchronization signal VSYNC is a periodic signal of a predetermined frequency (such as 60 Hz) indicating an imaging timing.

The DAC 231 generates a reference signal by digital to analog (DA) conversion. For example, a sawtooth-shaped ramp signal is used as the reference signal. The DAC 231 supplies the reference signal to the column signal processing unit 260. The reference signal is a signal having a voltage that changes over time with a predetermined inclination, and is used by the column signal processing unit 260 to detect a pixel signal.

The pixel circuit 250 generates an analog pixel signal by photoelectric conversion and supplies the analog pixel signal to the column signal processing unit 260.

The column signal processing unit 260 performs signal processing such as analog to digital (AD) conversion processing and correlated double sampling (CDS) processing on the pixel signal for each pixel column. The column signal processing unit 260 supplies image data including the processed digital signal to the DSP circuit 120 via the signal line 209. The column signal processing unit 260 may be referred to as an AD conversion unit.

The horizontal scanning circuit 270 controls the column signal processing unit 260 to sequentially output digital signals.

The slope detection circuit SD differentiates a voltage of the pixel signal and detects a slope of the voltage of the pixel signal. The slope detection circuit SD outputs the slope of the voltage of the pixel signal to the column signal processing unit 260. A more detailed configuration of the slope detection circuit SD will be described later.

The solid-state imaging element 200 illustrated in FIG. 2 may be configured as one semiconductor chip as a whole or may be constituted with a plurality of semiconductor chips. In a case where the solid-state imaging element 200 is constituted with a plurality of semiconductor chips, the pixel array unit 240 and the peripheral circuit unit 15 other than the pixel array unit 240 may be formed as separate semiconductor chips 511 and 512, and the semiconductor chip 511 of the pixel array unit 240 and the semiconductor chip 512 of the peripheral circuit unit 15 may be stacked.

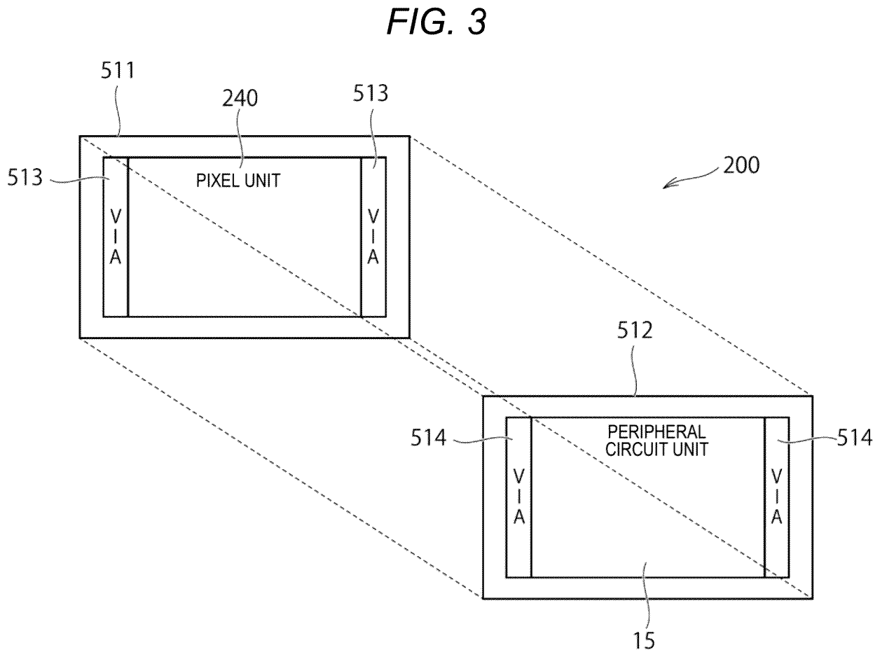

For example, FIG. 3 is a conceptual diagram illustrating an example of the solid-state imaging element 200 in which the semiconductor chip 511 of the pixel array unit 240 and the semiconductor chip 512 of the peripheral circuit unit 15 are stacked. As illustrated in FIG. 3, the solid-state imaging element 200 includes two stacked semiconductor chips 511 and 512.

The number of stacked semiconductor chips may be three or more. The semiconductor chip 511 includes the pixel array unit 240 formed on a semiconductor substrate. The semiconductor chip 512 includes the peripheral circuit unit 15 formed on another semiconductor substrate. Each pixel of the pixel array unit 240 of the semiconductor chip 511 and an element of the peripheral circuit unit 15 of the semiconductor chip 512 may be electrically connected using, for example, a through electrode such as a through silicon via (TSV) provided in a via region 513 and a via region 514. In addition, both the semiconductor chips may be bonded (Cu—Cu bonding) such that a wiring of the semiconductor chip 511 of the pixel array unit 240 and a wiring of the semiconductor chip 511 of the peripheral circuit unit 15 are brought into contact with each other. Furthermore, part of the pixel array unit 240 and the peripheral circuit unit 15 in FIG. 2 may be configured as one semiconductor chip, and the other configuration may be configured as another semiconductor chip.

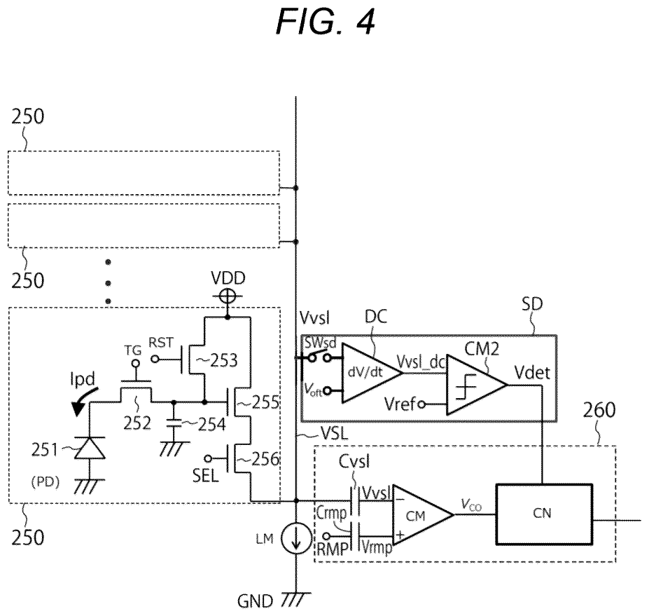

FIG. 4 is a circuit diagram illustrating a configuration example of the pixel circuit 250, the slope detection circuit SD, and the column signal processing unit 260 according to the first embodiment. The pixel circuit 250 includes a photoelectric conversion element 251, a transfer transistor 252, a reset transistor 253, a floating diffusion layer 254, an amplification transistor 255, and a selection transistor 256. The transfer transistor 252, the reset transistor 253, the floating diffusion layer 254, the amplification transistor 255, and the selection transistor 256 are, for example, constituted with an n-type MOS field effect transistor (MOSFET). Furthermore, in the pixel array unit 240, data signal lines VSL are wired for each pixel column along the vertical direction.

The photoelectric conversion element 251 performs photoelectric conversion on incident light to generate a pixel signal according to intensity of the incident light. The photoelectric conversion element 251 is, for example, a photodiode. An amount of electric charges generated or lost in the photoelectric conversion element 251 corresponds to intensity of the incident light. The incident light may include visible light, infrared light and/or ultraviolet light.

The transfer transistor 252 is connected between the photoelectric conversion element 251 and the floating diffusion layer 254. A transfer signal TG from the vertical scanning circuit 210 is supplied to a gate of the transfer transistor 252. The transfer transistor 252 is controlled by the transfer signal TG and transfers electric charges corresponding to the pixel signal to the photoelectric conversion element 251 and the floating diffusion layer 254.

The reset transistor 253 is connected between the floating diffusion layer 254 and a power supply line to which a power supply voltage VDD is supplied. A reset signal RST from the vertical scanning circuit 210 is input to a gate of the reset transistor 253. The reset transistor 253 is controlled by the reset signal RST and resets a potential Vfd of the floating diffusion layer 254 by the power supply voltage VDD.

The floating diffusion layer 254 is connected to a gate of the amplification transistor 255. The floating diffusion layer 254 functions as an input node (gate) of the amplification transistor 255. The floating diffusion layer 254 temporarily holds the electric charges accumulated in the photoelectric conversion element 251, and causes the electric charges corresponding to the pixel signal to flow to the photoelectric conversion element 251 or receives the electric charges from the photoelectric conversion element 251. As a result, the floating diffusion layer 254 generates a voltage corresponding to an amount of the electric charges corresponding to the pixel signal. The amplification transistor 255 amplifies the voltage of the floating diffusion layer 254.

The amplification transistor 255 and the selection transistor 256 are connected in series between the power supply line of the power supply voltage VDD and the data signal line VSL. By this means, the amplification transistor 255 is connected to the data signal line VSL via the selection transistor 256.

A selection signal SEL is supplied from the vertical scanning circuit 210 to a gate of the selection transistor 256. The selection transistor 256 is controlled by the selection signal SEL and selectively connects the amplification transistor 255 of the pixel circuit 250 to the data signal line VSL. Thus, if the selection transistor 256 becomes conductive, the amplification transistor 255 amplifies a potential Vfd of the floating diffusion layer 254 and outputs a voltage corresponding to the potential Vfd to the data signal line VSL as a pixel signal. The data signal line VSL transmits the pixel signal from the pixel circuit 250 to the column signal processing unit 14.

The gates of the transfer transistor 252, the reset transistor 253, and the selection transistor 256 are commonly connected to the vertical scanning circuit 210 for each pixel row. Thus, the vertical scanning circuit 210 can simultaneously drive the plurality of pixel circuits 250 included in one pixel row.

Note that the pixel circuit 250 is not limited to the circuit illustrated in the drawing as long as a pixel signal can be generated by photoelectric conversion.

The data signal line VSL is connected to a constant current circuit LM. The constant current circuit LM is configured to cause a constant current to flow through the data signal line VSL. As the constant current circuit LM, for example, a MOSFET is used. By the constant current circuit LM causing a constant current to flow through the data signal line VSL, the amplification transistor 255 transmits a pixel signal having a voltage corresponding to the potential of the floating diffusion layer 254 to the data signal line VSL.

The column signal processing unit 260 receives the pixel signal from the pixel circuit 250 via the data signal line VSL and performs AD conversion on the pixel signal. The column signal processing unit 260 includes a comparator CM, a counter CN, and capacitors Cvsl and Crmp. The comparator CM, the counter CN, and the capacitors Cvsl and Crmp are provided for each data signal line VSL, that is, for each pixel column. Thus, the plurality of pixel circuits 250 included in one pixel column shares the comparator CM, the counter CN, and the capacitors Cvsl and Crmp corresponding to the pixel column.

A first input terminal of the comparator CM is connected to the data signal line VSL via the capacitor Cvsl and receives the pixel signal. A second input terminal of the comparator CM is connected to the DAC 231 in FIG. 2 via the capacitor Crmp and receives the reference signal RMP. An output terminal of the comparator CM is connected to the counter CN and outputs a comparison result between a voltage Vvsl of the pixel signal and a voltage Vrmp of the reference signal RMP as an output signal Vco. Note that the capacitors Cvsl and Crmp are provided to implement an auto-zero function that cancels element variation of the comparator.

The DAC 231 linearly changes the voltage Vrmp of the reference signal RMP with a predetermined inclination. In other words, the reference signal RMP is a ramp signal having a predetermined inclination. The comparator CM inverts the output signal Vco when the voltage Vrmp of the reference signal RMP crosses the voltage Vvsl of the pixel signal. The counter CN counts a clock signal during a period from when the inclination of the reference signal RMP is started until the output signal Vco is inverted, and measures the period. As a result, the column signal processing unit 260 performs AD conversion on the pixel signal and generates a digital value corresponding to the pixel signal.

The slope detection circuit SD is connected between the data signal line VSL and the counter CN of the column signal processing unit 260. The slope detection circuit SD includes a differentiation circuit DC, a comparator CM2, and a switching element SWsd. The slope detection circuit SD is provided for each data signal line VSL, that is, for each pixel column.

The switching element SWsd is connected between the data signal line VSL and the differentiation circuit DC. For example, an n-type MOSFET is used as the switching element SWsd. For example, a p-type MOSFET may be used as the switching element SWsd. The switching element SWsd is controlled by the timing control unit 220 to be turned on (conductive state) or off (non-conductive state).

An input terminal of the differentiation circuit DC is connected to the data signal line VSL via the switching element SWsd. An output terminal of the differentiation circuit DC is connected to a first input terminal of the comparator CM2. The differentiation circuit DC performs time differentiation (dVvsl/dt) on the voltage Vvsl of the pixel signal obtained through the switching element SWsd to calculate a slope Vvsl_dc of the voltage Vvsl. The differentiation circuit DC outputs the slope Vvsl_dc as a differentiation result to the first input terminal of the comparator CM2. The configuration of the differentiation circuit DC is not particularly limited, but an embodiment will be described later.

The comparator CM2 is provided between the differentiation circuit DC and the column signal processing unit 260. The first input terminal of the comparator CM2 is connected to the output terminal of the differentiation circuit DC and receives the slope Vvsl_dc. A second input terminal of the comparator CM2 receives a threshold Vref. An output terminal of the comparator CM2 is connected to the counter CN. The comparator CM2 compares the slope Vvsl_dc with the threshold Vref and outputs the result as a slope detection signal Vdet. The threshold Vref is not a ramp signal having a slope but a signal set to a constant value. In a case where an absolute value of the slope Vvsl_dc is equal to or greater than an absolute value of the threshold Vref, the comparator CM2 inverts the slope detection signal Vdet. For example, the comparator CM2 activates the slope detection signal Vdet from a low level to a high level. In a case where the absolute value of the slope Vvsl_dc is smaller than the absolute value of the threshold Vref, the comparator CM2 maintains an inactive state while keeping the slope detection signal Vdet at the low level.

In a case where the slope detection signal Vdet is activated to the high level at the time of detection of a voltage level (hereinafter, also referred to as a reset level) of the pixel signal in a reset state not including data of the incident light, the counter CN sets a count value of the pixel signal to a maximum value (full code). As a result, in a case where intensity of the incident light is high and electric charges leak between the floating diffusion layer 25 and the photoelectric conversion element 251 at the time of detection of the reset level, the column signal processing unit 260 can set a digital value corresponding to the pixel signal to a maximum value (full code) and set luminance of the pixel to a maximum value (white-out).

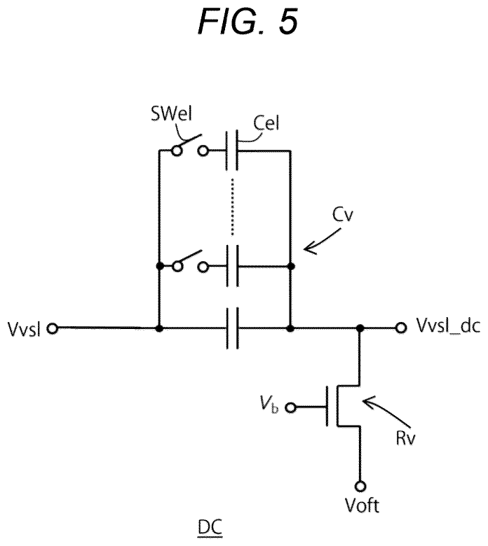

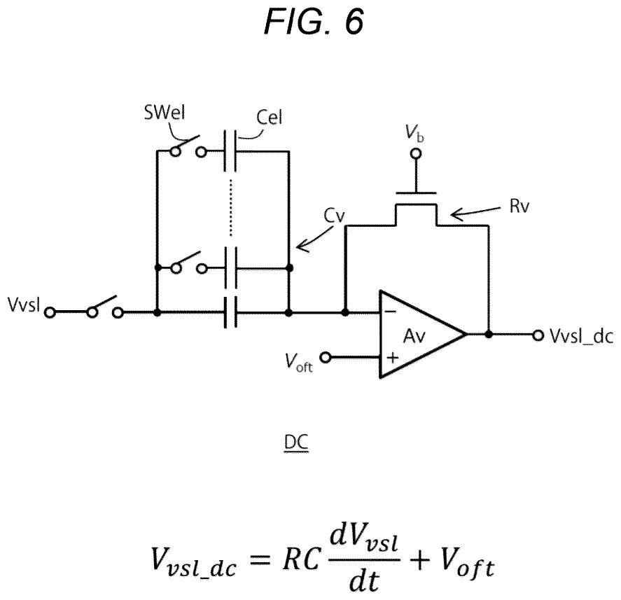

FIGS. 5 and 6 are views illustrating a configuration example of the differentiation circuit DC. FIG. 5 is an example of a passive differentiation circuit, and FIG. 6 is an example of an active differentiation circuit. A configuration of the differentiation circuit DC may be any one of FIGS. 5 and 6, and is not limited to these configurations.

The differentiation circuit DC of FIG. 5 includes a variable capacitor Cv and a variable resistor Rv. An input terminal of the differentiation circuit DC is connected to the data signal line VSL via the switching element SWsd and receives the voltage Vvsl of the pixel signal.

The variable capacitor Cv includes a plurality of capacitive elements Cel and a plurality of switching elements SWel. The plurality of capacitive elements Cel is provided corresponding to the plurality of switching elements SWel. The capacitive element Cel and the switching element SWel corresponding thereto form a pair. One pair of the capacitive element Cel and the switching element SWel is connected in series between an input terminal and an output terminal of the differentiation circuit DC. The plurality of pairs is connected in parallel between the input terminal and the output terminal of the differentiation circuit DC. Note that one capacitive element Cel may be connected between the input terminal and the output terminal of the differentiation circuit DC without passing through the switching element SWel.

The number of capacitive elements Cel connected in parallel between the input terminal and the output terminal of the differentiation circuit DC can be controlled by turning on/off the switching element SWel. As a result, a capacitance value of the variable capacitor Cv can be changed.

The variable resistor Rv is connected between the output terminal of the differentiation circuit DC and the power supply line of the offset voltage Voft. The variable resistor Rv is constituted with, for example, an n-type MOSFET. The variable resistor Rv may be constituted with a p-type MOSFET. A gate of the variable resistor Rv is controlled by receiving a voltage Vb. A resistance value of the variable resistor Rv changes by changing the voltage Vb. A differentiation value of the voltage Vvsl during the AD conversion is a value of 0 or less, and thus, the offset voltage Voft is set to a value of Vref or more so that the slope detection signal Vdet is inverted at the time of leakage.

Thus, if the capacitance value of the variable capacitor Cv is set as C and the resistance value of the variable resistor Rv is set as R, the differentiation circuit DC calculates Vvsl_dc by calculating Expression 1. The differentiation circuit DC is a passive differentiation circuit having a gain of R×C.

$$\begin{matrix}[ Math . 1 ] & \\ {V}_{vsl \_ dc} = RC \frac{{dV}_{vsi}}{dt} + {V}_{oft} & ( Expression 1 )\end{matrix}$$

The differentiation circuit DC of FIG. 6 includes the variable capacitor Cv, the variable resistor Rv, and an operational amplifier Av. Configurations of the variable capacitor Cv and the variable resistor Rv may be the same as those in FIG. 5.

The operational amplifier Av is connected between the variable capacitor Cv and the output terminal of the differentiation circuit DC. The variable resistor Rv is connected between an input terminal of the operational amplifier Av connected to the variable capacitor Cv and an output terminal of the operational amplifier Av.

As a result, if the capacitance value of the variable capacitor Cv is set as C and the resistance value of the variable resistor Rv is set as R, the differentiation circuit DC calculates Vvsl_dc by calculating Expression 1 above. The differentiation circuit DC is an active differentiation circuit having a gain of R×C.

In the differentiation circuit DC illustrated in FIGS. 5 and 6, the data signal line VSL and the comparator CM2 are separated from each other in terms of direct current by a variable capacitor. Thus, a current flowing through the data signal line VSL between the pixel circuit 250 close to the differentiation circuit DC and the pixel circuit 250 far from the differentiation circuit DC is not affected.

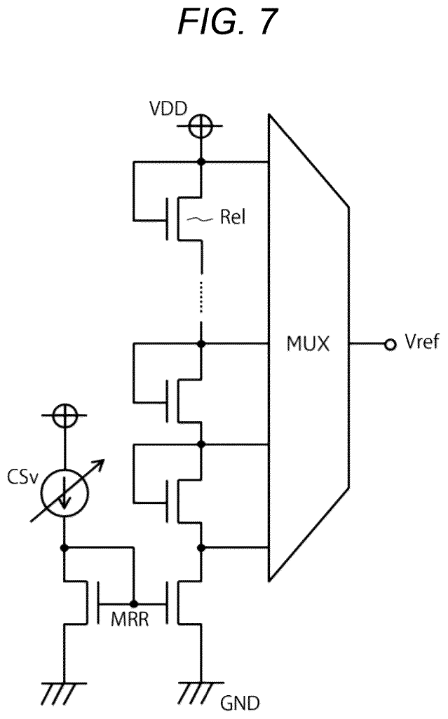

FIG. 7 is a view illustrating a configuration example of a Vref generation circuit that generates the threshold Vref.

The Vref generation circuit includes a plurality of resistance elements Rel, a mirror circuit MRR, a variable current source CSv, and a multiplexer MUX.

The plurality of resistance elements Rel is connected in series between the power supply line of the power supply voltage VDD and a ground GND. Each resistance element Rel is constituted with a diode-connected MOSFET. One end of each of the plurality of resistance elements Rel is connected to the multiplexer MUX, divides a voltage between the power supply voltage VDD and the ground voltage into a plurality of voltages different from each other, and outputs the divided voltages.

The mirror circuit MRR causes a current corresponding to the current flowing through the variable current source CS to flow through the plurality of resistance elements Rel.

The variable current source CS causes different currents to flow to the mirror circuit MRR according to setting.

The multiplexer MUX selectively outputs any of the plurality of voltages generated by the plurality of resistance elements Rel as the threshold Vref to the second input terminal of the comparator CM2 in FIG. 4.

As a result, the Vref generation circuit can supply various voltages to the comparator CM2 as the threshold Vref. The comparator CM2 can detect a slope of the voltage Vvsl of the data signal line VSL by changing the setting of the threshold Vref.

Next, operation of the imaging device 100 will be described.

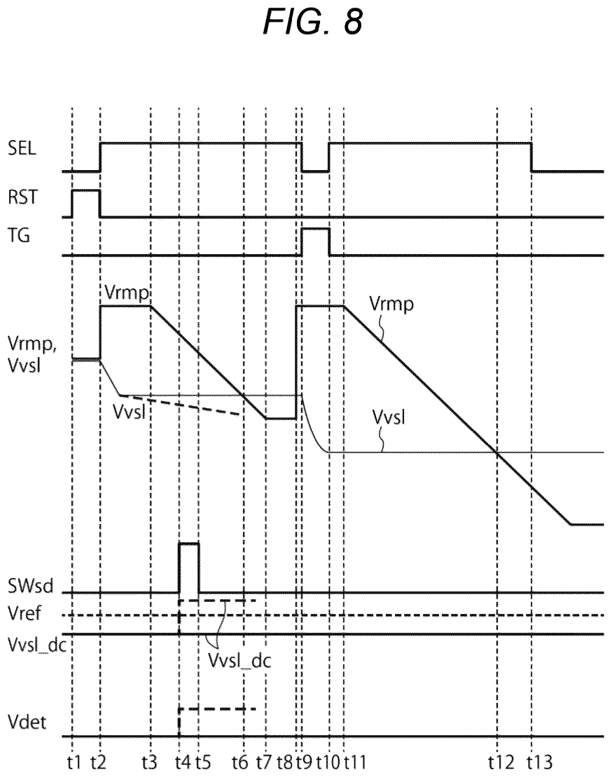

FIG. 8 is a timing chart indicating an example of operation of the imaging device 100 according to the first embodiment.

First, from t1 to t2, the vertical scanning circuit 210 causes the reset signal RST to rise. As a result, the reset transistor 253 is turned on, and the floating diffusion layer 254 is charged to a high level voltage by the power supply voltage VDD. In this event, the transfer transistor 252 and the selection transistor 256 are in an OFF state, and thus, a charged state of the floating diffusion layer 254 is maintained. As a result, the pixel circuit 250 is put into a reset state.

At t2, the vertical scanning circuit 210 lowers the reset signal RST and causes the selection signal SEL to rise. As a result, the reset transistor 253 is turned off, and the selection transistor 256 is turned on. A source of the amplification transistor 255 is electrically connected to the data signal line VSL. In this event, the transfer transistor 252 remains off, and thus, the pixel circuit 250 is maintained in the reset state. Thus, the gate voltage of the amplification transistor 255 (voltage of the floating diffusion layer 254) is maintained at a high level voltage, and the amplification transistor 255 transmits a high level voltage by the power supply voltage VDD to the data signal line VSL. Thus, even if incident light enters the pixel circuit 250, the voltage Vvsl of the data signal line VSL is maintained at a relatively high level.

Here, in the reset state, the transfer transistor 252 maintains the off state. Thus, the electric charge of the floating diffusion layer 254 is maintained, and thus, the reset level voltage Vvsl should be originally maintained at a relatively high level as indicated by the solid line in FIG. 8 even if the incident light enters the pixel circuit 250.

However, if the intensity of the incident light is high, as illustrated in FIG. 4, there is a case where the electric charges Ipd may leak from the floating diffusion layer 254 to the photoelectric conversion element 251 via the transfer transistor 252. In this case, the potential of the floating diffusion layer 254 gradually changes, and thus, a conductive state of the amplification transistor 255 changes. Thus, as indicated by a broken line in FIG. 8, the voltage Vvsl of the pixel signal at the reset level gradually decreases and has an inclination. As a result, a white image is somewhat blackened although the intensity of the incident light is high.

Thus, in the present embodiment, after the selection signal SEL rises at t2, the switching element SWsd is turned on during a period (t4 to t5) in which the pixel signal at the reset level is detected. As a result, the slope detection circuit SD is electrically connected between the data signal line VSL and the counter CN. In the slope detection circuit SD, the differentiation circuit DC performs time differentiation (dVvsl/dt) on the voltage Vvsl of the pixel signal to calculate the slope Vvsl_dc of the voltage Vvsl.

The comparator CM2 compares the slope Vvsl_dc of the voltage Vvsl with the threshold Vref and outputs the result as the slope detection signal Vdet.

For example, in a case where the intensity of incident light is not so high, electric charges hardly leak from the floating diffusion layer 254 to the photoelectric conversion element 251. In this case, as indicated by the solid line in FIG. 8, the voltage Vvsl is substantially flat and hardly inclined. Thus, the absolute value of the slope Vvsl_dc is less than the absolute value of the threshold Vref, and thus, the comparator CM2 maintains the inactive state while keeping the slope detection signal Vdet at the low level. In this case, the counter CN of the column signal processing unit 26 counts clock pulses during a period from an inclination start time point t3 of the voltage Vrmp of the reference signal RMP to a time point t6 at which the voltage Vrmp intersects the voltage Vvsl, and outputs the count value. As a result, the column signal processing unit 260 can perform AD conversion on the pixel signal at the reset level into a digital value.

On the other hand, for example, in a case where the intensity of the incident light is very high and electric charges leak from the floating diffusion layer 254 to the photoelectric conversion element 251, the voltage Vvsl has an inclination as indicated by a broken line in FIG. 8. In this case, the voltage Vvsl of the pixel signal at the reset level gradually decreases from a normal value. In such a case, if the column signal processing unit 260 performs AD conversion on the pixel signal at the reset level as usual, the digital value of the reset level becomes greater than the original value. This is because the voltage Vvsl gradually decreases due to leakage of electric charges, and the period from the inclination start time point of the voltage Vrmp of the reference signal RMP to the time point at which the voltage Vrmp intersects the voltage Vvsl becomes longer. Thus, if such a digital value of the reset level is subtracted from the digital value of the signal level using a correlated double sampling (CDS) method, the image is blackened. Note that the signal level is a level of the voltage Vvsl of the pixel signal including data of the incident light (according to the intensity of the incident light).

On the other hand, in the present disclosure, in a case where the intensity of the incident light is high and the absolute value of the slope Vvsl_dc of the voltage Vvsl is equal to or greater than the absolute value of the threshold Vref, the comparator CM2 activates the slope detection signal Vdet to the high level. In this case, the counter CN sets the count value to a maximum value. The column signal processing unit 260 receives the count value of the maximum value and outputs the pixel signal subjected to the CDS processing as a full-code digital value. Thus, the image becomes white with maximum luminance, and the intensity of the incident light can be accurately expressed. In this case, the AD conversion of the signal level after t5 may be omitted. The operation after t5 can be omitted, so that a frame rate can also be shortened.

Note that, as indicated by the solid line in FIG. 8, in a case where the absolute value of the slope Vvsl_dc is less than the absolute value of the threshold Vref, the AD conversion processing proceeds as follows.

At t5, the switching element SWsd is turned off. As a result, the slope detection circuit SD is electrically separated from the data signal line VSL. The switching element SWsd is turned on for a period (from t4 to t5) while the reset level is detected, and is turned off in other periods. As a result, it is possible to prevent the slope detection signal Vdet from being erroneously activated in a reset period, or the like.

If the voltage Vrmp of the reference signal RMP intersects the voltage Vvsl at t6, the operation of the reference signal Vrmp is stopped at t7. The counter CN outputs a count value of the pixel signal at the reset level.

At t8, the reference signal RMP is reset.

From t9 to t10, the vertical scanning circuit 210 lowers the selection signal SEL and turns off the selection transistor 256. Furthermore, the vertical scanning circuit 210 activates the transfer signal TG and turns on the transfer transistor 252. As a result, electric charges corresponding to the intensity of the incident light flow from the floating diffusion layer 254 to the photoelectric conversion element 251 via the transfer transistor 252, and the potential of the floating diffusion layer 254 becomes a potential corresponding to the intensity of the incident light.

At t10, the vertical scanning circuit 210 lowers the transfer signal TG and turns off the transfer transistor 252. As a result, the floating diffusion layer 254 is electrically separated from the photoelectric conversion element 251. In addition, the vertical scanning circuit 210 activates the selection signal SEL and turns on the selection transistor 256. As a result, a source of the amplification transistor 255 is electrically connected to the data signal line VSL.

In this event, the gate voltage of the amplification transistor 255 (voltage of the floating diffusion layer 254) is set to a potential corresponding to the intensity of the incident light. Thus, the amplification transistor 255 transmits the pixel signal at the signal level to the data signal line VSL.

At t11, the DAC 231 starts operation of the reference signal RMP. The comparator CM compares the voltage Vrmp of the reference signal RMP with the voltage Vvsl of the pixel signal, and outputs an output signal Vco as a comparison result. At t12 when the voltage Vrmp intersects the voltage Vvsl of the pixel signal, the comparator CM inverts the logic of the output signal Vco.

The counter CN counts clock pulses and outputs a count value thereof during a period from an inclination start time point t11 of the reference signal Vrmp to a time point t12 at which the logic of the output signal Vco is inverted (the voltage Vrmp intersects the voltage Vvsl). Thus, the column signal processing unit 260 can perform AD conversion on the pixel signal at the signal level into a digital value.

The column signal processing unit 260 can calculate an accurate digital value of the pixel signal excluding a dark current component by subtracting the digital value of the reset level from the digital value of the signal level using a correlated double sampling (CDS) method.

According to the present disclosure, the differentiation circuit DC time-differentiates the voltage Vvsl of the pixel signal at the reset level to calculate the slope Vvsl_dc of the voltage Vvsl. The comparator CM2 compares the slope Vvsl_dc as the differentiation result with the threshold Vref. In a case where the absolute value of the slope Vvsl_dc is equal to or greater than the absolute value of the threshold Vref, the comparator CM2 activates the slope detection signal Vdet to the high level. In this case, the counter CN sets the count value to a maximum value. In this case, the column signal processing unit 260 outputs the maximum value (full code) of the digital value of the pixel signal subjected to the CDS processing. Thus, the image corresponding to the pixel circuit 100 can be made white with the maximum luminance (whiteout), and the intensity of the incident light can be accurately expressed. As a saturation electric charge amount (Qs) of the pixel circuit 250 is higher, the greater effect can be obtained. Furthermore, in this case, the AD conversion operation of the signal level after t5 can be omitted, so that the frame rate can be shortened.

As a comparative example, a method of lowering the current value of the constant current circuit LM and preventing the reference signal RMP from reaching the signal level in a case where the intensity of the incident light is high is conceivable. However, if the current value of the constant current circuit LM is lowered, a settling period until the voltage Vvsl is stabilized at the reset level or the signal level becomes long, and random telegraph noise (RTN) may increase.

On the other hand, in the present disclosure, an image is overexposed on the basis of the slope Vvsl_dc of the voltage Vvsl. It is therefore not necessary to lower the current value of the constant current circuit LM. As a result, in the present disclosure, the settling period of the voltage Vvsl does not become long, and the RTN does not increase.

Note that the slope detection circuit SD may be provided for each data signal line VSL (for each pixel column). However, the slope detection circuit SD may be provided on the data signal lines VSL intermittently selected among all the data signal lines VSL. In other words, the slope detection circuit SD may be disposed by thinning out the data signal line VSL. The slope detection circuit SD hardly changes the current flowing through the data signal line VSL. Thus, the slope of the reset level voltage Vvsl is substantially constant during the AD conversion. As a result, the slope detection circuit SD can accurately detect the slope even if the slope detection circuit SD is thinned out.

### Second Embodiment

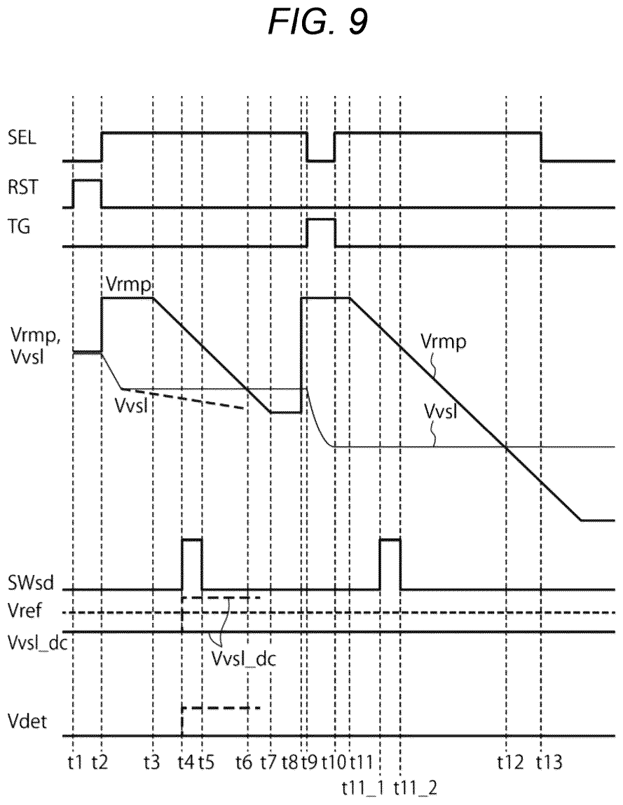

FIG. 9 is a timing chart indicating an example of operation of the imaging device 100 according to a second embodiment. In the second embodiment, in a case where the reset level voltage Vvsl is not inclined by an amount equal to or greater than the threshold, the switching element SWsd is turned on not only during the AD conversion of the reset level but also during the AD conversion of the signal level. Other configurations of the second embodiment may be the same as those of the first embodiment.

In FIG. 9, operation from t1 to t11 may be the same as the operation from t1 to t11 indicated in FIG. 8. Note that, in a case where the reset level voltage Vvsl is inclined by an amount equal to or greater than the threshold, the operation of the imaging device 100 is the same as the operation of the first embodiment. On the other hand, in a case where the reset level voltage Vvsl is not inclined by an amount equal to or greater than the threshold, the switching element SWsd is turned on from t11-1 to t11_2 during the AD conversion operation of the signal level.

A period from t11 to t12 is a period in which the pixel signal at the signal level is converted into the digital value, and the switching element SWsd is turned on during this AD conversion.

A length of the period from t11 to t11-1 is approximately equal to a length of the period from t3 to t4. In other words, the switching element SWsd is put into the conductive state at t4 at which the period (first period) from t3 to t4 has elapsed after the AD conversion of the reset level is started (that is, from the start of the inclination of the reference signal Vrmp). Furthermore, the switching element SWsd is put into the conductive state at time t11_1 at which a first period (from t11_1 to t11_2) equal to the period from t3 to t4 has elapsed after the AD conversion of the signal level is started (that is, from the start of the inclination of the reference signal Vrmp).

In a case where the switching element SWsd is turned on only during the AD conversion of the pixel signal at the reset level, noise such as streaking may occur in the pixel signal of the data signal line VSL due to an instantaneous current flowing through the slope detection circuit SD.

On the other hand, according to the second embodiment, the switching element SWsd is turned on in the corresponding period (from t3 to t4 and from t11_1 to t11_2) during the AD conversion of the pixel signal at the reset level and the AD conversion of the pixel signal at the signal level. As a result, noise such as streaking is canceled by performing CDS processing on the digital value of the reset level and the digital value of the signal level in the column signal processing unit 260. As a result, a digital value of the pixel signal with less noise can be obtained.

Other operation of the second embodiment may be the same as the operation of the first embodiment. Thus, the second embodiment can also obtain the effects of the first embodiment.

### Third Embodiment

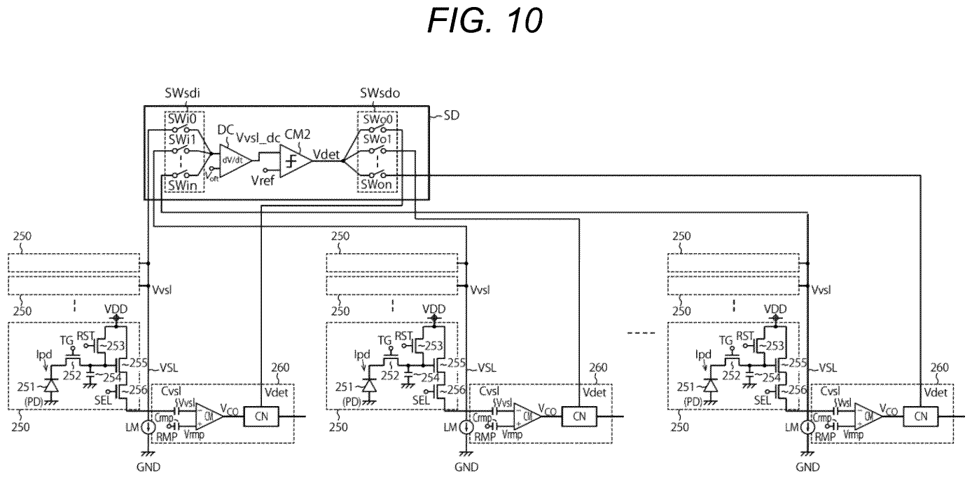

FIG. 10 is a timing chart indicating an example of operation of the imaging device 100 according to a third embodiment. In the third embodiment, the slope detection circuit SD is provided in common for the plurality of data signal lines VSL (that is, a plurality of pixel columns). In this case, the slope detection circuit SD is connected between the plurality of data signal lines VSL and the plurality of column signal processing units 260 corresponding to the plurality of data signal lines VSL.

The slope detection circuit SD according to the third embodiment includes a first switching element group SWsdi, a second switching element group SWsdo, the differentiation circuit DC, and the comparator CM2. The configurations of the differentiation circuit DC and the comparator CM2 may be the same as those of the first embodiment.

The first switching element group SWsdi includes a plurality of first switching elements SWi0 to SWin (n is an integer of 1 or more). The first switching elements SWi0 to SWin are provided corresponding to the plurality of data signal lines VSL (that is, the pixel column), and are connected between the corresponding data signal line VSL and the differentiation circuit DC.

The second switching element group SWsdo includes a plurality of second switching elements SWo0 to SWon. The second switching elements SWo0 to SWon are provided corresponding to the data signal lines VSL (that is, the pixel column), and are connected between the corresponding column signal processing unit 260 and the comparator CM2.

Each of the first and second switching elements SWi0 to SWin and SWo0 to SWon may be constituted with a MOSFET.

The first switching element SWik (k=0 to n) and the second switching element SWok corresponding to the selected one data signal line VSL among the first switching elements SWi0 to SWin are turned on. The other first switching elements SWi0 to SWik, SWik+1 to SWin and the second switching elements SWo0 to SWok, SWok+1 to SWon are maintained in an off state. As a result, the slope detection circuit SD is selectively electrically connected between the selected one data signal line VSL and the counter CN of the column signal processing unit 260 corresponding to the data signal line VSL. The slope detection circuit SD detects the slope of the pixel signal from the selected one data signal line VSL.

Other configurations of the third embodiment may be the same as the configurations of the first or second embodiment. According to the third embodiment, the slope detection circuit SD is provided corresponding to the plurality of data signal lines VSL, and thus, a circuit scale of the imaging device 100 is reduced, and the layout area is also reduced.

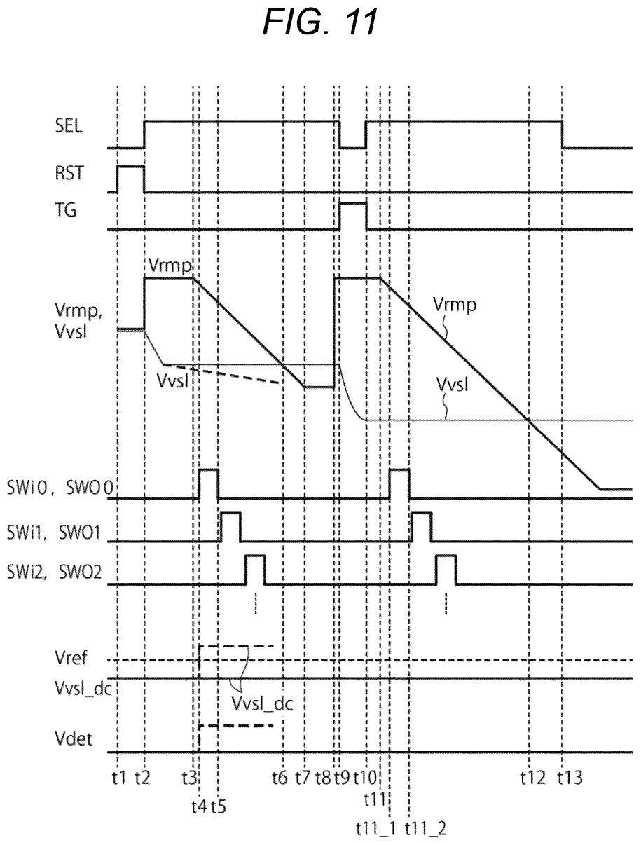

FIG. 11 is a timing chart indicating an example of operation of the imaging device 100 according to the third embodiment. In the third embodiment, in one time of inclination operation of the reference signal Vrmp, pairs of the first and second switching elements SWik and SWok corresponding to the plurality of data signal lines VSL are sequentially turned on.

For example, after the inclination of the reference signal Vrmp is started at t3, the pair of the first and second switching elements SWi0 and SWo0 is turned on at t4, and the pair of the first and second switching elements SRi0 and SWo0 is turned off at t5. Next, the pair of the first and second switching elements SWi1 and SWo1 is turned on and turned off. Next, the pair of the first and second switching elements SWi2 and SWo2 is turned on and turned off. This is repeated, and the pairs of the first and second switching elements SWik and SWok are sequentially turned on and off.

As a result, the slope detection circuit SD can detect the slope of the reset level of the data signal lines VSL of the plurality of columns in one time of inclination operation of the reference signal Vrmp at the time of AD conversion of the reset level.

Also at the time of the AD conversion of the signal level, the pairs of the first and second switching elements SWik and SWok are sequentially turned on and off in one time of inclination operation of the reference signal Vrmp. A period from when the inclination of the reference signal Vrmp is started until the first and second switching elements SWik and SWok are turned on and off is equal between the AD conversion of the reset level and the AD conversion of the signal level. Accordingly, also in the third embodiment, the settling period of the voltage Vvsl does not become long, and the RTN does not increase.

In addition, the slope detection circuit SD is provided in common for the plurality of data signal lines VSL, so that power consumption can be reduced.

Other operation of the third embodiment may be similar to the operation of the first or second embodiment. Thus, the third embodiment can obtain the same effects as the effects of the first or second embodiment.

Note that the slope detection circuit SD may detect the slope of the reset level voltage Vvsl for all the data signal lines VSL. However, the slope detection circuit SD may detect the slope of the reset level voltage Vvsl for the data signal lines VSL intermittently selected among all the data signal lines VSL. The slope detection circuit SD hardly changes the current flowing through the data signal line VSL. Thus, the slope of the reset level voltage Vvsl is substantially constant during the AD conversion. As a result, even if the slope detection circuit SD detects the slope of the voltage Vvsl for the intermittently selected data signal lines VSL, the slope detection circuit SD can accurately detect the slope.

In a case where the slope of the voltage Vvsl is detected for the intermittently selected data signal lines VSL, the first and second switching elements SWi0 to SWin and SWo0 to SWon may be provided respectively corresponding to the n data signal lines VSL. However, the first and second switching elements SWi0 to SWin and SWo0 to SWon may be provided corresponding to the data signal lines VSL intermittently selected among all the data signal lines VSL, and the others may be omitted.

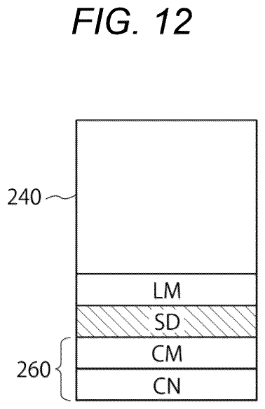

FIG. 12 is a plan view illustrating an example of a layout position of the slope detection circuit SD. If the slope detection circuit SD is closer to the pixel array unit 240 than the constant current circuit LM, a wiring from the constant current circuit LM to the pixel array unit 240 becomes longer. In this case, wiring resistance from the constant current circuit LM to the pixel circuit 250 increases.

Thus, the slope detection circuit SD is disposed at a position farther from the pixel array unit 240 than the constant current circuit LM. For example, the slope detection circuit SD is disposed between the constant current circuit LM and the comparator CM of the column signal processing unit 260. This makes it possible to suppress an increase in wiring resistance from the constant current circuit LM to the pixel circuit 250.

### (Application Example to Mobile Body)

The technology according to the present disclosure (present technology) can be applied to various kinds of products. For example, the technology according to the present disclosure may be embodied in the form of a device to be mounted on a mobile body of any kind, such as an automobile, an electric vehicle, a hybrid electric vehicle, a motorcycle, a bicycle, a personal mobility, an airplane, a drone, a vessel, or a robot.

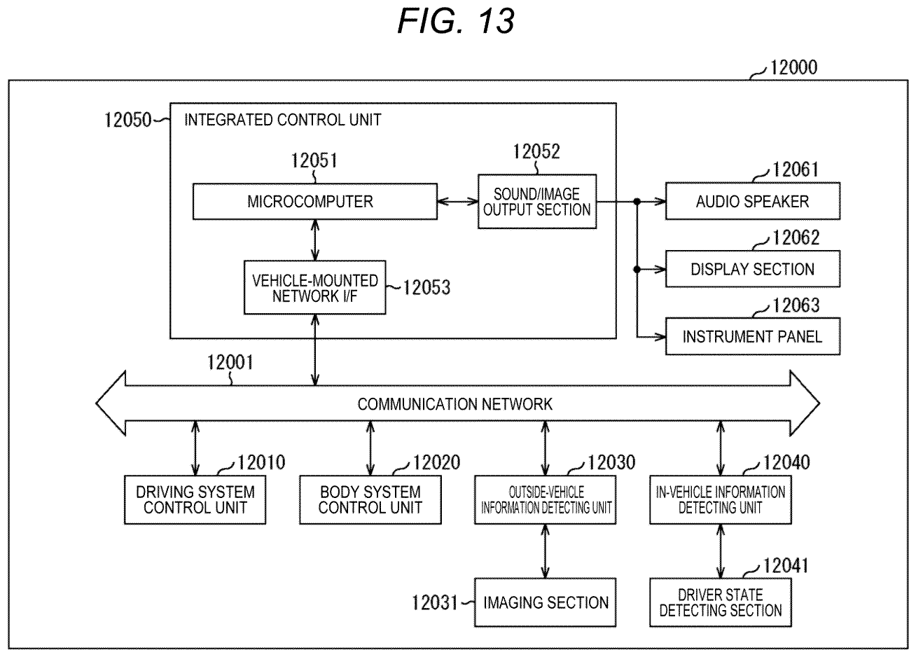

FIG. 13 is a block diagram illustrating a schematic configuration example of a vehicle control system being an example of a mobile body control system to which the technology according to the present disclosure can be applied.

The vehicle control system 12000 includes a plurality of electronic control units connected to each other via a communication network 12001. In the example depicted in FIG. 13, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 13, an audio speaker 12061, a display section 12062, and an instrument panel 12063 are illustrated as the output device. The display section 12062 may, for example, include at least one of an on-board display and a head-up display.

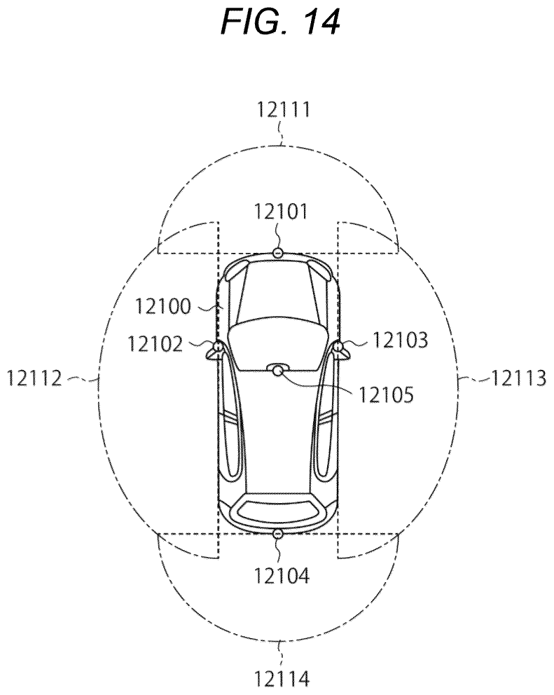

FIG. 14 is a view illustrating an example of an installation position of the imaging section 12031.

In FIG. 14, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 14 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031, and the like, for example, among the configurations described above.

Note that the present technology can also have the following configurations.

(1)

An imaging device including:
a pixel unit including a plurality of pixels that photoelectrically converts incident light to generate a pixel signal;
a first signal line that transmits the pixel signal from the pixel unit;
a signal processing unit that converts the pixel signal into a digital value;
a differentiation circuit that is provided between the first signal line and the signal processing unit, differentiates the pixel signal, and outputs a differentiation result; and
a first comparison unit that is provided between the differentiation circuit and the signal processing unit, compares the differentiation result with a predetermined threshold, and outputs a comparison result to the signal processing unit.
   (2)

The imaging device according to (1), in which the first comparison unit inverts the comparison result in a case where an absolute value of the differentiation result of the pixel signal not including data of the incident light is equal to or greater than an absolute value of the threshold.

(3)

The imaging device according to (2), in which the signal processing unit sets the digital value to a maximum value when the first comparison unit inverts the comparison result.

(4)

The imaging device according to any one of (1) to (3), further including a switching element provided between the differentiation circuit and the first signal line.

(5)

The imaging device according to (4), in which the switching element is brought into a conductive state during a period in which the pixel signal not including data of the incident light is converted into the digital value.

(6)

The imaging device according to any one of (1) to (5), in which
a plurality of the first signal lines is provided, and
the differentiation circuit and the first comparison unit are provided for each of the first signal lines.
   (7)

The imaging device according to any one of (1) to (6), in which
a plurality of the first signal lines is provided, and
the differentiation circuit and the first comparison unit are provided on first signal lines intermittently selected among the plurality of first signal lines.
   (8)

The imaging device according to any one of (1) to (7), in which
the signal processing unit includes:
a second comparison unit that compares the pixel signal with a reference signal having a voltage that changes with a predetermined inclination, and inverts an output when the reference signal crosses the pixel signal; and
a counter that counts a clock signal during a period from when change of the reference signal is started until the output is inverted by the second comparison unit, and
when the first comparison unit inverts the comparison result, the counter sets a count value to a maximum value.
   (9)

The imaging device according to (5), in which the switching element is brought into a conductive state during a period in which the pixel signal including the data of the incident light is converted into the digital value.

(10)

The imaging device according to (9), in which the switching element is brought into a conductive state when a first period has elapsed after start of digital conversion of the pixel signal not including the data of the incident light, and is brought into a conductive state when the first period has elapsed after start of digital conversion of the pixel signal including the data of the incident light.

(11)

The imaging device according to any one of (1) to (10), in which a plurality of the first signal lines is provided, and
the differentiation circuit and the first comparison unit are provided in common for the plurality of first signal lines.
   (12)

The imaging device according to (11), further including:
a plurality of first switching elements provided between the differentiation circuit and each of the plurality of first signal lines; and
a plurality of second switching elements provided between the first comparison unit and the signal processing unit corresponding to each of the plurality of first signal lines.
   (13)

The imaging device according to (12), in which the plurality of first switching elements and the plurality of second switching elements are provided corresponding to the plurality of first signal lines.

(14)

The imaging device according to (12), in which the plurality of first switching elements and the plurality of second switching elements are provided corresponding to first signal lines intermittently selected among the plurality of first signal lines.

(15)

The imaging device according to (8), further including
a current circuit that causes a current to flow through the first signal line,
in which the differentiation circuit and the first comparison unit are disposed at positions farther from the pixel unit than the current circuit.

Note that the present disclosure is not limited to the above-described embodiments, and various modifications can be made without departing from the gist of the present disclosure. Furthermore, the effects described in the present description are merely examples and are not limited, and other effects may be provided.

### REFERENCE SIGNS LIST

100 Imaging device
110 Optical unit
200 Solid-state imaging element
210 Vertical scanning circuit
220 Timing control unit
231 DAC
240 Pixel array unit
260 Column signal processing unit
270 Horizontal scanning circuit
SD Slope detection circuit
DC Differentiation circuit
CM2 Comparator
SWsd Switching element
CM Comparator
CN Counter
Cvsl, Crmp Capacitor

1. An imaging device comprising:
a pixel unit including a plurality of pixels that photoelectrically converts incident light to generate a pixel signal;
a first signal line that transmits the pixel signal from the pixel unit;
a signal processing unit that converts the pixel signal into a digital value;
a differentiation circuit that is provided between the first signal line and the signal processing unit, differentiates the pixel signal, and outputs a differentiation result; and
a first comparison unit that is provided between the differentiation circuit and the signal processing unit, compares the differentiation result with a predetermined threshold, and outputs a comparison result to the signal processing unit.

2. The imaging device according to claim 1, wherein the first comparison unit inverts the comparison result in a case where an absolute value of the differentiation result of the pixel signal not including data of the incident light is equal to or greater than an absolute value of the threshold.

3. The imaging device according to claim 2, wherein the signal processing unit sets the digital value to a maximum value when the first comparison unit inverts the comparison result.

4. The imaging device according to claim 1, further comprising a switching element provided between the differentiation circuit and the first signal line.

5. The imaging device according to claim 4, wherein the switching element is brought into a conductive state during a period in which the pixel signal not including data of the incident light is converted into the digital value.

6. The imaging device according to claim 1, wherein a plurality of the first signal lines is provided, and
the differentiation circuit and the first comparison unit are provided for each of the first signal lines.

7. The imaging device according to claim 1, wherein a plurality of the first signal lines is provided, and
the differentiation circuit and the first comparison unit are provided on first signal lines intermittently selected among the plurality of first signal lines.

8. The imaging device according to claim 1,
wherein the signal processing unit includes:
a second comparison unit that compares the pixel signal with a reference signal having a voltage that changes with a predetermined inclination, and inverts an output when the reference signal crosses the pixel signal; and
a counter that counts a clock signal during a period from when change of the reference signal is started until the output is inverted by the second comparison unit, and
when the first comparison unit inverts the comparison result, the counter sets a count value to a maximum value.

9. The imaging device according to claim 5, wherein the switching element is brought into a conductive state during a period in which the pixel signal including the data of the incident light is converted into the digital value.

10. The imaging device according to claim 9, wherein the switching element is brought into a conductive state when a first period has elapsed after start of digital conversion of the pixel signal not including the data of the incident light, and is brought into a conductive state when the first period has elapsed after start of digital conversion of the pixel signal including the data of the incident light.

11. The imaging device according to claim 1, wherein a plurality of the first signal lines is provided, and
the differentiation circuit and the first comparison unit are provided in common for the plurality of first signal lines.

12. The imaging device according to claim 11, further comprising:
a plurality of first switching elements provided between the differentiation circuit and each of the plurality of first signal lines; and
a plurality of second switching elements provided between the first comparison unit and the signal processing unit corresponding to each of the plurality of first signal lines.

13. The imaging device according to claim 12, wherein the plurality of first switching elements and the plurality of second switching elements are provided corresponding to the plurality of first signal lines.

14. The imaging device according to claim 12, wherein the plurality of first switching elements and the plurality of second switching elements are provided corresponding to first signal lines intermittently selected among the plurality of first signal lines.

15. The imaging device according to claim 8, further comprising a current circuit that causes a current to flow through the first signal line,
wherein the differentiation circuit and the first comparison unit are disposed at positions farther from the pixel unit than the current circuit.
